(19) United States
(12) Patent Application Publication
(10) Pub. No.: US 2015/0329387 A1
(43) Pub. Date: Nov. 19, 2015

(54) SYSTEMS AND METHODS FOR GENERATING HALOAMINES AND APPLICATION THEREOF IN OIL AND GAS OPERATIONS

(71) Applicant: BUCKMAN LABORATORIES INTERNATIONAL, INC., Memphis, TN (US)

(72) Inventors: Theodore SUMRALL, Fort Walton Beach, FL (US); Christopher WIATR, Collierville, TN (US); Josee CHALUT, Bartlett, TN (US)

(21) Appl. No.: 14/714,591

(22) Filed: May 18, 2015

Related U.S. Application Data
(60) Provisional application No. 62/000,136, filed on May 19, 2014.

(51) Int. Cl. C02F 1/50; E21B 43/16; C09K 8/60; C09K 8/03; C02F 1/70; C01B 21/09

(52) U.S. Cl. CPC C02F 1/50; C02F 1/70; C01B 21/091; C09K 8/605; C09K 8/032; E21B 43/16; C02F 2103/10

(57) ABSTRACT

The present invention relates to systems and methods for the on-site generation (for example at oil well drilling operations, oil well hydraulic fracturing operations, makeup water pipeline transportation systems, and oil and gas refining operations) of haloamine chemistry such as chloramines and/or bromamines. The invention also relates to the application of the generated haloamines to control microorganisms such as bacteria as well their harmful byproducts such as hydrogen sulfide and other undesired substances found in oil and gas industries.

### CROSS REFERENCE TO RELATED APPLICATIONS

This application claims priority to U.S. Provisional Application No. 62/000,136 filed May 19, 2014, which is hereby incorporated by reference in its entirety.

### BACKGROUND

1. Field of the Invention

The present invention relates to systems and methods for the on-site generation (for example at oil well drilling operations, oil well hydraulic fracturing operations, makeup water pipeline transportation systems, and oil and gas refining operations) of haloamine chemistry such as chloramines and/or bromamines. The invention also relates to the application of the generated haloamines to control microorganisms such as bacteria as well their harmful byproducts such as hydrogen sulfide and other undesired substances found in oil and gas industries.

The invention relates generally to the use of haloamines, such as chloramines and bromamines, generated onsite in oilfield operations.

2. Description of Related Art

There is an ongoing need for improved methods and system for controlling undesired microorganisms in many industries and a need exists for more environmentally friendly methods of controlling microorganisms which have a greater persistence and greater ability to control these microorganisms. Typical methods involve the employment of chlorine in the form of chlorine gas or hypochlorous acid made from bleach. However, while these chemicals react quickly against the organisms of interest, they also react with other organic or carbon containing material in the water often generating undesirable chlorocarbon byproducts such as chloroform and carbon tetrachloride, both of which are very undesirable insomuch that they are hazardous and dangerous chemicals.

With the decline in the use of gaseous chlorine as a microbicide and bleaching agent due to environmental reasons, various alternative biocides have been explored, including bleach, bleach with bromide, bromochlorodimethyl hydantoin, chlorinated and brominated triazines, ozone, chlorine dioxide (ClO₂) and monochloramine (NH₂Cl).

Of these, monochloramine (MCA) has generated a great deal of interest for control of microbiological growth in a number of industries, including the dairy industry, the food and beverage industry, the pulp and paper industries, the fruit and vegetable processing industries, various canning plants, the poultry industry, the beef processing industry, and miscellaneous other food processing applications.

The use of monochloramine is rising in potable water applications such as: municipal potable water treatment facilities; potable water pathogen control in office building and healthcare facilities; industrial cooling loops; and in industrial waste treatment facilities, because of its selectivity towards specific environmentally-objectionable waste materials. Prior methods for the control of microorganisms in these potable water applications typically involved the employment of bleach or chlorine gas resulting in the formation of hypochlorous acid (HOCl) which then reacts with other carbon containing substances in the water lines and forms the aforementioned chlorocarbons rendering the HOCl essentially useless and unable to control the microorganisms of interest. Therefore, as a result of the above benefits, chloramines are currently being utilized as disinfectants in public water supplies and bromamines are currently being used as disinfectants in the medical community and for the disinfection of swimming pool and cooling tower waters. Chloramine is commonly used in low concentrations as a secondary disinfectant in municipal water distribution systems (and is normally generated at the municipal water treatment site using anhydrous ammonia) as an alternative to chlorination. Chlorine is therefore being displaced by chloramine—primarily monochloramine (NH₂Cl or MCA) which is much more stable and does not dissipate as rapidly as free chlorine and has a much lower tendency than free chlorine to convert organic materials into chloro-carbons such as chloroform and carbon tetrachloride.

Unlike chlorine dioxide or chlorine which can vaporize into the environment, monochloramine remains in solution when dissolved in aqueous solutions and does not ionize to form weak acids. This property is at least partly responsible for the biocidal effectiveness of monochloramine over a wide pH range.

Methods for the production of chloramines are well known in the art. For example, chloramine can be produced by one or more techniques described in U.S. Pat. Nos. 4,038,372; 4,789,539; 6,222,071; 7,045,659; and 7,070,751.

The microbicidal activity of monochloramine is believed to be due to its ability to penetrate bacterial cell walls and react with essential amino acids within the cell cytoplasm to disrupt cell metabolism (specifically sulfhydryl groups —SH). This mechanism is more efficient than other oxidizers that “burn” on contact and is highly effective against a broad range of microorganisms. MCA has demonstrated excellent performance against difficult to kill filamentous bacteria and slime-forming bacteria and has shown better penetration and removal of biofilm when compared to traditional biocides.

Furthermore, MCA has demonstrated: excellent results for maintaining system cleanliness; better penetration and removal of biofilm; reduction of inorganic and organic deposits; reduced system cleaning frequency; improved cooling efficiency; better disinfecting properties than conventional oxidants; better performance in high-demand systems, it is not impacted by system pH; and is efficient against Legionella and Amoeba.

Additionally, MCA demonstrates very effective control of hydrogen sulfide by reacting with the hydrogen sulfide itself to form nonhazardous byproducts.

Unfortunately, MCA can become unstable and hazardous under certain temperature and pressure conditions. Although this may only be an issue of concern for solutions of relatively high concentration(s), its shipment, at any concentration, is highly restricted. MCA and other haloamines have not been used in the petroleum industry due to a number of safety related issues such as on site storage concerns of pressurized anhydrous ammonia and because shipment of MCA is difficult and furthermore, the MCA will degrade over time if manufactured at one site and shipped to another.

In the petroleum industry, numerous agents or contaminants can cause damage to or restriction of the production process. A number of microorganisms have been proven to cause a wide range of negative effects on oil and gas operations ranging from reduced formation flow (due to biofilm formation) to corrosion (as a result of acid formation such as H₂S) resulting in subsequent equipment failure. Many of the polymers utilized in oil and gas production operations can be metabolized by such microorganisms resulting in polymer performance degradation and higher growth rates for these microorganisms. Examples of such polymers are: polyacrylamides; carboxymethylcellulose (CMC); hydroxyethylcellulose (HEC); hydroxypropyl guar (HPG); acrylamidomethylpropanesulfonic acid (AMPS) and Xanthan.

Some of these contaminants found in oil and gas applications, such as bacteria, can, in some cases, occur naturally in a formation or be present from prior human interactions (ex. microbes introduced from makeup water or contaminated equipment employed in the recovery of oil and gas). For example, bacteria are often inadvertently introduced to a formation during drilling and workover (e.g. the repair or stimulation of an existing production well) operations. Similarly, during a fracturing process, bacteria are often inadvertently introduced into the wellbore and forced deep into the formation (For example, as a result of contaminated or improperly treated waters or contaminated proppants being injected into the formation). Additionally, during these processes and practices, the bacteria are spread and with the subsequent distribution of these bacteria, it is possible that bacteria with new cellular and biochemical technologies are made available to new locations and new (to them) nutrients which can accelerate their growth and proliferation. The slime-former organisms grow and develop and secrete sticky, slime exopolymer that adhere to surfaces. As inorganic materials adhere to the slime exopolymer, a hard mass will develop. These hard masses block important passages in the recovery of oil and gas.

Often polymers such as CMC, HPG, Xanthan, AMPS and polyacrylamides are added to the fracturing fluid to maintain the proppant in suspension and to reduce the friction of the fluid. Bacteria entrained within this fluid penetrate deep into the formation, and once frack pressure is released, become embedded within the strata (in the same manner as the proppant deployed) and these polymers then become nutrients for bacteria to grow and multiply.

Many bacteria that are found in oil and gas application are facultative anaerobes. That is, they can exist (metabolize) in either aerobic or anaerobic conditions using either oxygen (i.e. molecular oxygen or other oxygen sources (ex. NO₃) or non-oxygen electron acceptors (ex. sulfur) to support their metabolic processes. Under the right conditions, facultative anaerobes can use sulfate as an oxygen source and respire hydrogen sulfide, which is highly toxic to humans in addition to being highly corrosive to steel. Additionally, in a process known as Microbiologically Induced Corrosion (MIC), bacteria will attach to a substrate, such as the wall of a pipe in the wellbore or in a formation which has undergone hydraulic fracturing, and form a “biofilm” shield around them. Underneath, the bacteria metabolize the substrate (ex. a mixture of hydrocarbon and metallic iron) and respire hydrogen sulfide, resulting in the metal becoming severely corroded in the wellbore, leading to pipe failure and damage to downhole equipment, costly repairs, and downtime. The production of hydrogen sulfide as byproduct also complicates the refining and transportation processes, and reduces the economic value of the produced hydrocarbon. Hydrogen sulfide is a poisonous and explosive gas and therefore a serious safety hazard. Thus, the presence of hydrogen sulfide makes operations unsafe to workers and can be costly to the operators in terms of down time and damage to expensive equipment.

Traditional methods, when used alone to address these problems, often have drawbacks. For example, a present industry practice is to add conventional organic and inorganic biocides, such as quaternary ammonium compounds, aldehydes (such as. Glutaraldehyde), THPS and sodium hypochlorite, to fracturing fluids and possibly other additives to control bacteria. The efficacy of these conventional biocides alone, however, can be minimal due to the type of bacteria that typically are found in hydrocarbon-bearing formations and petroleum production environments. More particularly, only a small percentage of these bacteria which are native to the formation (which are often found in volcanic vents, geysers, and ancient tombs) are active at any one time; the remainder of the population is present in a dormant or spore state. The aforementioned conventional biocides often have no, or limited, effect on dormant and endospore forming bacteria. Thus, while the active bacteria are killed to some extent, the inactive bacteria survive and thrive once favorable environmental conditions are achieved within the formation. Additionally, these conventional biocides often become inactivated when exposed to many of the components found in petroleum production formations and, furthermore, microorganisms can build resistance to these conventional biocides, thus limiting their utility over time.

Currently, numerous microbicides are available on the market for the oil and gas industry. But many of these microbicides are of concern due to potential long term detrimental effects such as introduction into aquifers. There exists a strong need for a “green biocide” which can accomplish the stated objectives but which (if inadvertently introduced into an aquifer or other water supply intended for human and/or animal consumption) will not result in nearly as serious debilitating effects.

Owing to a number of safety related issues such as on site storage concerns of pressurized anhydrous ammonia, until the present invention, the use of haloamines in the oil and gas industry has not been proposed, and employment of portable haloamine generators has not been applied in the upstream, midstream, or downstream in the oil and gas industry. The instant invention has overcome these issues.

There is a continuing need for improved biocides that can be used in the oil and gas industry. Among the biocides currently being utilized in the oil and gas industry, biocides such as: glutaraldehyde; THPS; quaternary amines, and acrolein are or have been used. The toxicity of these biocides can be of significant concern to oil and gas field operating personnel. For example, the latter biocide (acrolein) has a very high toxicity and can even dissolve the rubber soles and heels of worker's shoes and boots. Typically, such biocides are fed manually into a containment tank in “slug dosage” exposing the operating personnel to potentially serious risk. The instant invention described here prepares the chloramine chemistry in a fresh manner and meters it into the location where it is needed rather than exposing personnel to the chemical directly.

There is also a continuing need for improvements in portable monochloramine generation in terms of costs, design considerations, and ease of use for industries heretofore not utilizing this technology such as the oil and gas industry.

The present invention addresses these and other needs.

### SUMMARY OF THE INVENTION

An advantage of the invention is the ability to safely generate haloamines, such as chloramines and/or bromamines, on-site without the need to transport and employ anhydrous ammonia (which is classified as a “Hazardous Material” by DOT and OSHA and classified as an “Extremely Hazardous Substance by EPA) and utilize the generated chloramine as a microbicide and/or as a hydrogen sulfide (H2S) scavenger/neutralizer.

A second advantage of the invention is to be able to employ this safe and portable technology for application in oil and gas related operations. The ability to deliver previously manufactured chloramine to a drilling or fracking site is limited due to the fact that pure chloramine is very dangerous and transportation of diluted chloramine is uneconomical. The present invention overcomes these limitations.

To achieve these and other advantages, there has been provided in accordance with the present invention a method for onsite generation of a haloamine comprising mixing an ammonium salt with water and optionally a base to form a stable composition which does not convert to a haloamine, mixing said stable composition with a halogen or halogen-containing compound under conditions in which all or a part of the ammonium salt is converted into a haloamine, and optionally injecting the resulting haloamine into an injection zone.

There has also been provided a method for inhibiting microbial and other contaminants contained in an oil or gas well, comprising contacting the well with one or more chloramines or bromamines, which has preferably been produced on-site.

There is also provided a system for generating a haloamine, comprising a storage container comprising a stable composition which is a reaction product of an ammonium salt with water and optionally a base which does not convert to a haloamine until reacted with a halogen, and haloamine generator equipment, preferably wherein the haloamine generator equipment is portable and contains a source of halogen.

There is also provided a method of controlling bacteria and impurities in oil and gas field water, comprising treating the waters with a chloramine or bromamine that has been generated onsite.

Further objects, features, and advantages of the invention will become apparent from the detailed description that follows.

### BRIEF DESCRIPTION OF THE DRAWINGS

The present invention may be more fully understand with reference to the accompany figure. The figures are intended to illustrate exemplary features of the invention without limiting its scope.

FIG. 1 is a diagram showing onsite generation of chloramine according to the present invention.

FIG. 2 is a chart comparing effectiveness of three different biocides.

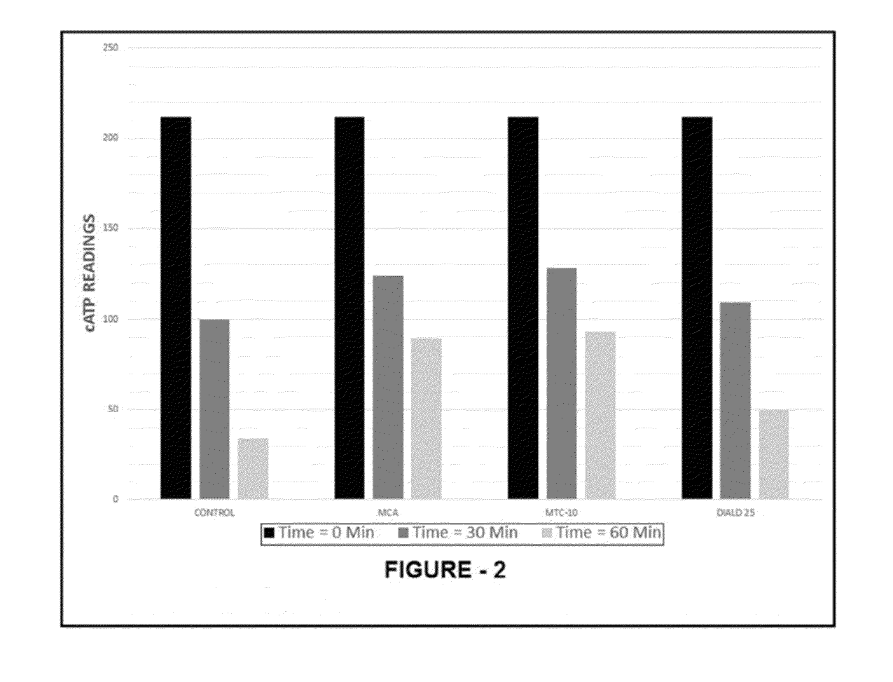

FIG. 3 is a chart comparing effectiveness of three different biocides adjusted for relative activity concentration.

FIG. 4 is a chart comparing the effectiveness of biocide of the invention compared to a comparison biocide.

FIG. 5 is a chart comparing percent kill of a biocide of the invention to a comparison biocide.

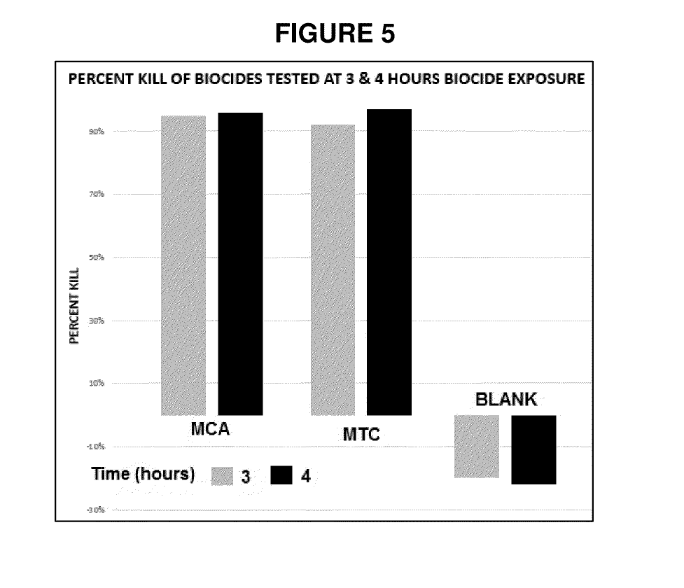

### DETAILED DESCRIPTION

The present invention relates to methods and systems for the onsite generation of a haloamine. Examples of the haloamine generated include monochloramine, dichloramine, trichloramine, monobromamine, dibromamine, tribromamine, and mixture of two or more of these haloamines. The haloamine produced according to the invention is preferably a chloramine or bromamine and the production of monochloramine is especially preferred.

Any desired ammonium salt can be used in the present invention. The cation component of the ammonium salt can comprise ammonium (NH₄⁺) and/or ammonia (NH₃). One or more of any known ammonium salts can be used. Examples include ammonium acetate; ammonium bicarbonate; ammonium bromide; ammonium chloride; ammonium fluoride; ammonium hexafluorophosphate; ammonium hydrogensulfate; ammonium nitrate; ammonium phosphate; ammonium sulfamate; ammonium sulfate; ammonium sulfite; ammonium trifluoroacetate; ammonium trifluoromethanesulfonate; ammonium hydroxide, and mixtures of any two or more of these salts. Ammonium sulfate is an especially preferred salt.

Any desired bases can optionally be used in the invention. A base can be used to control the amount of haloamine being formed. Examples include sodium hydroxide or potassium hydroxide or any alkali metal hydroxide as well as other hydroxides such as ammonium hydroxide. A base is preferably used.

The ammonium salt, water, and optionally a base are blended or mixed together to form a stable composition known as Busan-1474. The components are mixed together in amounts and under conditions that can be determined by one skilled in the art to produce a stable composition. The Busan-1474 is preferably formulated to allow for a concentrated ammonium salt solution with sufficient base to bring the pH up to a range of 9.0 to 12.5, although a wider range is acceptable, ideally a pH of between 10.0 to 11.5 is more desirable. By stable it is meant that the Busan-1474 does not convert to a chloramine or bromamine at this stage because a halogen source will not be present at this stage.

This composition can be transported in tanks or other container to locations, where makeup fluids and waters; recycled fluids and waters; flowback fluids and waters; injection fluids and waters, and produced fluids and waters employed in oil field operations (ex., drilling, stimulation, hydraulic fracturing, production, and disposal operations) can be treated. The composition can be stored until desired to be used for up to a year at standard temperatures and pressures (STP). At the location where the final haloamine is to be used, the stable composition (identified as Busan-1474) can be introduced into a mixing chamber under conditions where all or a part of the ammonium salt is converted into a haloamine, by mixing the stable composition with a halogen or source of halogen.

Any desired halogen source can be used in the invention. The halogen source acts as an oxidant which reacts with the ammonium salt to produce a haloamine. Examples include sodium hypochlorite (NaClO), sodium hypobromite (NaBrO), chlorine, bromine, a chlorine-releasing compound (such as calcium hypochlorite (Ca(ClO)₂), or a bromine-releasing compound (such as calcium hypobromite (Ca(BrO)₂), chlorinated hydantoins, brominated hydantoins, Chloramine-T, Chloramine-B, and mixtures thereof. While fluorine is also possible as a halogen source (and the fluoroamines are in fact more stable), when handling difficulties and economic factors are considered, the preferred embodiments of the instant invention utilize chlorine or bromine as the halogen source. Other alkali metal hypohalites or alkaline earth metal hypohalites can be used. Sodium hypochlorite is especially preferred.

One skilled in the art can select desired amounts and conditions for formations of the desired haloamine. Ideally, Busan-1474 is formulated to achieve a molar ratio of up to 1:1 of chlorine to nitrogen. Lower amounts of chlorine are acceptable, however at higher ratios of chlorine to nitrogen (ex. a ratio of 1.5 chlorine to 1.0 nitrogen), the ammonia will be converted to nitrogen gas. Acceptable ranges include molar ratios of 0.1 chlorine to 1.0 of nitrogen up to a molar ratio of 1.4 chlorine to 1.0 nitrogen. A range of between 0.5 chlorine to 1 nitrogen and 1.2 chlorine to 1 nitrogen is more desirable. Ratios between the ranges of 0.6 chlorine to 1 nitrogen and 1.1 chlorine to 1 nitrogen is more preferred. Ideally, the most desirable molar ratios are 1:1 chlorine to nitrogen. Before use, the BSH-1474 is usually diluted with water. Typical dilution ratios of BSN-1474 with water can range between 0.1 to 2% BSN-1474 with water, but a range of 0.3 to 1.6% BSN-1474 with water is more desirable. Ideally, however, the preferred dilution ratios should be between 0.6 to 1.2% BSN-1474 to water.

Methods of producing monochloramine are described in Provisional Application No. 61/912,037, filed Dec. 5, 2013, by the applicant of the present invention. This provisional application is incorporated by reference in its entirety.

The present invention includes methods to mitigate microorganism concentration in process waters used in the oil and gas industries, including upstream (i.e. at the well site), midstream (i.e. pipelines, holding tanks) or downstream (refinery operations). The method can be performed as part of oil and gas water treatment processes. Process water containing microbes can be treated with a chloramine(s) or other haloamines. The treatment can be performed in any suitable manner. The treatment can be continuous, substantially continuous, intermittent, cyclic, batch, or any combination thereof. Preferably the treatment maintains an effective amount of chloramine in the process water to achieve one or more benefits mentioned in the instant invention and generally this effective amount is achieved by maintaining a residual amount of chloramine in the process water over a long continuous period of time. The treatment can be performed at one or more stages or locations in the oil and gas water treatment systems. For example, the treatment can be performed in a vessel such as a frack tank or frack pond, and/or at one or more locations upstream and/or downstream of the drilling fluid pit or hydraulic fracturing injections point. A target residual chloramine value or range can be achieved by the treatment. For example, the process water can have a residual chloramine amount of from about 0.3 ppm to about 15 ppm (or chlorine equivalents). The ppm level is expressed as chlorine equivalents as is known and understood by those skilled in the art, and are not as actual chloramine ppm's in the process water. This residual amount can be determined, for instance, at the fracturing tank, or just after the fracturing tank (as just one example of a measurement location). Microbes can be initially present in the un-treated water in a desired amount.

The instant invention also includes in certain embodiment methods for microorganism control and water protection in oil and gas production, transportation and refining process or other processes which comprises a dual treatment of process water containing microbes with biocide and oxidants. For example, the produced haloamine can be used with one or more other biocides or oxidants. The biocide (e.g., chloramine and/or other halo amine) can reduce or eliminate microorganisms capable of producing metal and/or polymer (ex. starch) degrading enzymes (ex. amylase) and acids (ex. hydrogen sulfide) in the process waters.

The oxidant (e.g., sodium hypochlorite and/or other oxidants) can provide microbial control to eliminate residual enzymatic activity of metal and polymer degrading enzymes (such as those produced by microorganisms) or other enzymes. With the indicated dual treatment, enzyme substrates (such as injected polymers, starches or other enzyme substrates or metal used in the oil recovery, transportation or refining processes) can be protected from degradation by such enzymes. The dual treatment method can reduce or eliminate counts of bacteria and/or other microorganisms that are polymer and/or metal degrading enzymes in process water containing the microorganisms as compared to treatment of the process water containing the microorganisms without the biocide and oxidant. The dual treatment further can reduce or eliminate starch-degrading enzyme counts in the treated process water as compared to treatment of the process water containing microbes without the biocide and oxidant.

The produced haloamine can be used to control bacteria and other contaminants, for example, on the site where the haloamine was formed. Haloamine is injected and/or contacted with an injection zone to control bacteria and other contaminants. The injection zone can include a) a geologically produced material that contains one or more solid, liquid, or gaseous hydrocarbons; b) a hydrocarbon deposit; c) a petroleum deposit; d) a hydrocarbon or petroleum product formation; e) a hydrocarbon, or petroleum containing product; f) a hydrocarbon, or petroleum extraction site including drilling, hydraulic fracturing, production, stimulation, and/or disposal sites; g) hydrocarbon or petroleum transportation facility or storage equipment including pipeline, mobile tanker loading facilities, storage tanks and/or h) a refining facility, products, processes-equipment, or combinations thereof and/or any and all waters and fluids associated with items a-h including waters and fluids associated with: i) drilling; j) stimulation; .k) production; l) hydraulic fracturing; and m) disposal.

The injection zone can also include a hydrocarbon or petroleum processing product or equipment selected from of one or more pieces of equipment for extracting, processing, transportation, such as a pipeline for transporting hydrocarbons, storage, such as a vessel for storage of hydrocarbons, or refining hydrocarbons, or any and all waters such as fresh, brine, sea, brackish, or stored and fluids used in any hydrocarbon production processes including waters and fluids associated with: drilling; stimulation; production; hydraulic fracturing, and disposal.

The haloamines, such as chloramine and/or bromamine produced in the invention can be used to reduce, inactivate, destroy, or eliminate one or more of bacteria; algae; fungi; archaea; and/or other microbes, in locations needing such treatment. For example, in (i) makeup waters or fluids (ii) recycled waters or fluids (iii) flowback waters or fluids, (iv) injection waters or fluids, (v) produced waters or fluids or (vi) other waters or fluids; found or employed in oil field: drilling; stimulation; hydraulic fracturing; production and/or disposal operations.

The haloamines, such as chloramine and/or bromamine can be used to reduce, inactivate, destroy, or eliminate one or more of organic sulfhydryl reducing agents (ex. the sulfhydryl groups found on microbe cell wall membranes such as Streptomyces albus or Escherichia coli) and/or inorganic sulfide reducing agents (ex. hydrogen sulfide or elemental sulfur), reduced metals (ex. Cu⁺²), or other —SH reduced organic compounds, and mixtures thereof, in any location needing such treatment. For example, in (i) make-up waters or fluids (ii) recycled waters or fluids (iii) flowback waters or fluids, (iv) injection waters or fluids, (v) produced waters or fluids or (vi) other waters or fluids found or employed in oil field: drilling; stimulation; hydraulic fracturing; production and/or disposal operations.

The haloamine can be used to treat waters or fluids, including waters or fluids used or found in upstream, midstream and/or downstream petroleum operations, comprising fresh water, aquifer water, brine water, sea water, brackish water, river waters, lake waters, pond waters, stored waters or any combination thereof.

As an example, the present invention includes the treatment of makeup waters utilized in oil and gas exploration and production operations for operations such as drilling and hydraulic fracturing.

The present invention provides systems and method for generating haloamines, such as monochloramine and/or monobromamine onsite via portable or permanent generators and more particularly, to systems and methods employing a combination of reactants for generating monochloramine and/or monobromamine at higher yields (i.e. 100% conversion) for employment in upstream, midstream and downstream oil and gas water treatment operations.

The ability to generate haloamines such as MCA at a drilling or fracking site with portable generators or permanent generators (such as in the case of long term sour well control) allows the safe and economical generation of MCA without having to resort to the employment of dangerous anhydrous ammonia.

Monochloramine produced according to the invention is especially advantageous in oil and gas applications because it can inactivate or kill active, dormant and endospore-forming microorganisms which are often found as native to the oil and gas bearing formations. In the endospore state, endospore-forming microorganisms are naturally resistant to non-oxidizing biocides (such as glutaraldehyde, THPS). Unlike many conventional non-oxidizing biocides, microorganisms do not build a resistance to monochloramine. The oxidizing power of MCA degrades the exosporium and the cortex of the endospore, which starts to expose the endospore contents to MCA. The result is endospore destruction.

Haloamines (such as chloramine and bromamine) as produced in the present invention are also much more persistent and much more stable compared to other chlorine containing chemicals, much less reactive with organic or carbon containing materials and therefore the haloamines will have a greater ability to reach and control more microorganisms without most (if not all) of the undesirable by products associated with traditional chlorine treatment chemistries. However, chloramine itself has a brief shelf life relative to other chlorine microbe control agents. If chloramine is made in a plant off-site and then shipped, it would not be present at nearly the originally manufactured concentration by the time it arrives at the application point. So, in order to take advantage of the microorganism controlling power of chloramines, in accordance with the present invention the product is generated on site. The unit used to generate the chloramines prepares the chloramine chemistry so that the chloramines are significantly more potent than if generated at another location and then transported to the usage site.

The ability to generate and apply fresh MCA on site decreases the amount of microorganisms responsible for the detrimental effects described above and controls the microorganisms so that they cannot degrade these polymers. In addition, the MCA reacts with many of the enzymes these microorganisms produce, causing permanent and irreversible damage to enzymes. The ability to manufacture MCA on site furthermore assures a higher concentration of MCA is delivered and in a much safer manner than if concentrated MCA were delivered via delivery vehicle.

This invention also helps mitigate the hydrogen sulfide and at the same time improve the economics for the oil and gas operators.

Monochloramine is also a much safer alternative to traditional biocides utilized in the oil and gas industry

The disclosed design ensures a safe, yet optimal haloamine, e.g. monochloramine and/or monobromamine preparation with: an accurate dilution rate; exact addition rates to ensure precise equimolar mixing ratio; a distribution of stable dosing mixture; a variable/adjustable number of addition points; full flexibility for each addition point; program choices of continuous feed, timed feed or batch feed; addition times which are fully independent dosing times on each line, and dosage rates which are individually regulated for every addition point, again to optimize performance and to ensure safe operations at throughout the system. One skilled in the art can select desired amounts and conditions for formations of the desired haloamine. For example, monochloramine can be formed by reacting a molar ratio of up to 1:1 chlorine to nitrogen. Ideally, Busan-1474 is formulated to achieve a molar ratio of up to 1:1 of chlorine to nitrogen. Lower amounts of chlorine are acceptable, however at higher ratios of chlorine to nitrogen (ex. a ratio of 1.5 chlorine to 1.0 nitrogen), the ammonia will be converted to nitrogen gas. Acceptable ranges include molar ratios of 0.1 chlorine to 1.0 of nitrogen up to a molar ratio of 1.4 chlorine to 1.0 nitrogen. A range of between 0.5 chlorine to 1 nitrogen and 1.2 chlorine to 1 nitrogen is more desirable. However, ratios between the ranges of 0.6 chlorine to 1 nitrogen and 1.1 chlorine to 1 nitrogen is more preferred. Ideally, the most desirable molar ratios are 1:1 chlorine to nitrogen. Typical dilution ratios of BSN-1474 with water can range between 0.1 to 2% BSN-1474 with water, but a range of 0.3 to 1.6% BSN-1474 with water is more desirable. Ideally, however, the preferred dilution ratios should be between 0.6 to 1.2% BSN-1474 to water.

In one embodiment of an upstream application of the invention in oil and gas drilling, fracking, and/or production, oil field waters containing microbes can be treated with one or more chloramines or bromamines generated on site. A majority (by weight) of the chloramine can be MCA (such as at least 50.1%, at least 60%, at least 70%, at least 80%, at least 90%, at least 95%, at least 99% or 100%. The treatment can be performed in any suitable manner. The treatment can be continuous, substantially continuous, intermittent, cyclic, batch, or any combination thereof. The treatment can be performed at one or more stages or locations in the oil and gas upstream operations. For example, the treatment can be performed in a vessel such as a fracking tank, holding pond, mud pits, makeup water pipeline, or any combinations thereof. Generally, the treatment(s) occurs where the microbes are present in the makeup water prior to being combined with other additives (such as polymers).

The bromamine (preferably monobromamine or MBA) or chloramine (preferably MCA) can be used without other biocides, or used with biocides known to be used in the industry. The haloamines can be used with or without additives typically used in the oil and gas industry, including polymers such as polyacrylamides; carboxymethylcellulose (CMC); hydroxyethylcellulose; hydroxypropyl guar (HPG); acrylamidomethylpropanesulfonic acid (AMPS) and Xanthan; and other biocides. Quaternary biocides are quite compatible with this chemistry as well as non-oxidizing halogen containing biocides (such as 1,4-bisbromoacetoxy-2-butene (BBAB) as well as certain non-oxidizing non-halogen containing biocides. This technology does not preclude the employment of other possibly incompatible biocides as long as the haloamine generated by the instant invention is fed separately (and preferably at separate times to permit thorough dispersion) from the possibly incompatible biocide.

In another embodiment of an upstream application of the technology, in order to provide larger volumes of water over long distances for oil and gas operations, pipelines can be employed to transport this water from its source (ex. a river) to the point of use (ex. drilling site, fracking site, etc.). Employment of a portable or permanent chloramine generator as described at various sites along the pipeline will help to safely ensure that the water delivered to the use location is free of undesirable and problem causing microbes.

In another embodiment of a midstream application of the invention, oil which is transported in pipelines to refinery locations often contains residual water that can cause problems during transportation and at the refinery. Such problems can arise in stretches of pipeline that run at lower pressures. In these spots, water droplets can coalesce and fall out of the oil flow. They might inundate globs of sand or dirt that have also fallen out of the crude-oil mix and form a watery “sludge” on the edge of the pipe. Once a watery sludge forms in one part of the pipe, the natural process of corrosion speeds up. For example, the gram positive bacteria Clostridium is not facultative, but is an obligate anaerobe, requiring complete absence of oxygen and will grow under these deposits. As part of Clostridium metabolism, they produce organic acids which are corrosive. The sludge can also serve as a breeding ground for anaerobic bacteria, which form slimy, sulfur-producing deposits on the inside of the pipe. These deposits lead to additional corrosion of piping and pipelines and souring of the crude oil. The employment of these portable chloramine generators along the pipeline (ex. every 10 miles) will help ensure that undesirable microbes and endospore forming bacteria will not be able to breed and cause corrosion, sludge and/or biofilm buildup.

In an embodiment of a downstream application of the invention, bacterial MIC action often constitutes a major cause of corrosion in petroleum refineries and similar plants. In refineries, the problem can occur in areas such as storage facilities for both crude and refined petroleum products. Microbiologically Induced Corrosion (MIC) is a common type of corrosion in oil and gas storage and transportation facilities. Among different types of bacteria, sulfate reduction bacteria (SRB) are an important type of microbe that has caused numerous failures in oil gas storage facilities. These anaerobic bacteria use sulfate as an acceptor to create sulfide according to the following reaction:

SO₄²⁻+5H₂=H₂S+4H₂O

Due to metabolic processes, SRB consumes hydrogen that is produced by cathodic reaction. Also, H₂S is a by-product of SRB metabolism that can increase the corrosion rate by influencing on anodic reaction. In fact, SRB depolarizes both cathodic and anodic reactions to raise the corrosion rate. MCA according to the invention is effective at killing SRB. Furthermore, owing to MCA reaction with inorganic sulfides, the MCA also eliminates Hydrogen Sulfide produced by SRB providing an additional safety and corrosion control benefits.

### Example 1

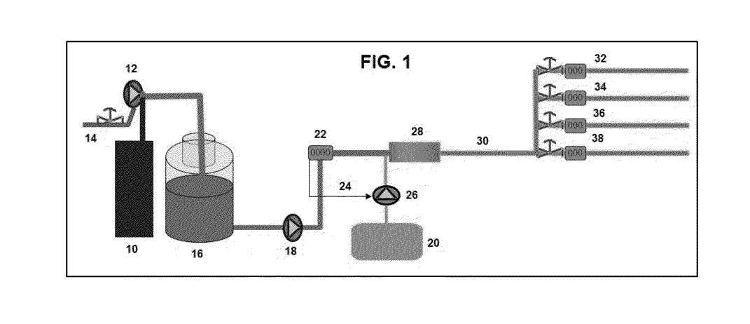

A process according to the invention is described with reference to FIG. 1.

In order to safely permit the manufacture of MCA on site, anhydrous ammonia has been eliminated from the process. Instead, an ammonium salt (for example, ammonium sulfate (≈92%), a small amount of base (in one case sodium hydroxide (<1%) and water (≈6%) have been pre-blended to form an ammonia containing product designated as Busan-1474 and placed into a portable storage container (10) (for example a tote bin) which can be refilled and safely transported and reconnected to the portable MCA generating equipment (Numbers 12 and above in the figure) as needed.

The Busan-1474 is further fed from the storage container (10) into the portable MCA generating equipment (via a Dosatron pump (12)) and further diluted with water (14) and stored in a dilute Busan-1474 storage tank (16). As needed, the dilute Busan-1474 is pumped from the storage tank (16) through an inverter regulated pump (18) through a flow meter (22) to a mixing chamber (28). The flow meter (22) via a 4 mA to 20 mA signal (24) commands the flow regulated bleach pump (26) to inject a precise ratio of liquid sodium hypochlorite to the mixing chamber to ideally achieve a molar ratio of up to 1:1 of chlorine to nitrogen (28) where chloramine is formed which is then routed to the specific applications (ex. Fracking Tanks (32, 34, 36, 38)). Element (20) is a storage tank for the sodium hypochlorite.

In an embodiments of the invention chloramine and/or bromamine is fed into an injection zone at a dosage rate covering the range of slug feed, intermittent feed and/or continuous feed. For example, to give a residual chloramine or bromamine range of 0.1 to 50 ppm after demand of the chloramine or bromamine has been met by the system to which the haloamine is injected.

### Example 2

Producing oil and gas fields generally have significant volumes of water mixed with oil and/or gas. These waters are generally very high in Total Dissolved Solids ((TDS), including ions such as: calcium; carbonate; barium; sulfate, and the like, which can lead to scaling. These waters also often contain microorganisms that are detrimental to the production field because they are able to cause souring of the wells and the formation and can cause serious corrosion problems. Many scaling problems are a direct result of corrosion problems; therefore, if corrosion can be controlled then generally scaling problems are also much easier to control.

This produced water is separated from the oil and gas via various chemical and mechanical methods. The separated water is then re-injected into the formation in order to keep the oil/gas at a level where it can be pumped from the level where the well is located and to prevent subsidence of the land whereon the drilling and pumping equipment is located.

The present invention, as demonstrated by this example, can be used to control such corrosion problems.

Test Method

A one-liter sample of water was obtained from the mechanical water/oil/gas separator from a producing oil field in the western USA. The one liter sample was separated into four aliquots, one control and three test samples.

Adenosine triphosphate (ATP) is the energy source for all living organisms. Measurement of the ATP concentration in a water sample gives a good indication of the concentration of total biological organism concentration. A number of different companies including 3M and LuminUltra manufacture test kits. For this testing, the LuminUltra QBG test kit was employed.

The control sample was tested for total ATP concentration (on a mass per milliliter basis (pg/mL)) and was found to have a concentration of approximately 212 pg/mL of ATP.

Each of the non-control samples were dosed with one of three different biocides: MTC-10 (a 10% solution of methylenebis(thiocyanate) at 22 ppm active concentration; Diald 25 (a 25% solution of Glutaraldehyde) at 50 ppm active; and monochloramine (MCA) at a concentration of 7.5 ppm. After 30 and 60 minutes of exposure, ATP levels were measured and recorded.

The test results indicate that MCA according to the invention performed (on a product percentage basis) as well as MTC-10 and better than Diald-25. The results are shown in Figure-2.

Additionally, when analyzed from an activity percentage basis (relative to Diald 25), then MCA worked greater than 3× as effectively as MTC-10 at 30 minutes and 60 minutes of exposure and the MCA performed almost 2× better than Diald-25 during the first 30 minutes, and more than 20% better than Diald-25 at 60 minutes of exposure. This is shown in Figure-3.

### Example 3

In an oil and gas field in the western USA, MCA was tested in comparison with methylene bis(thiocyanate), (MTC) in a weekly batch treatment and is fed for 2-3 hours at 200 ppm (as product).

The chlorine demand on this water is about 2,500-5,000 ppm and therefore, not used in these systems.

A solution of MCA Working Solution was prepared using Busan 1474 and Bulab 6004 (high alkalinity bleach). The reaction of these two components diluted in water at the proper equimolar ratios and proper pH produces a stable high concentration of biocide. A known concentration of MCA was added to a specific volume of influent water which had to be captured under anaerobic conditions and kept in an incubation chamber when not being used because the primary organisms of interest (anaerobes) are very susceptible to both oxygen and temperature changes. Therefore, as soon as the samples were collected, the head space of the bottles were purged with Nitrogen and then sealed with a rubber stopper (which will permit the insertion of a hypodermic needle) and then crimped into place with an aluminium seal.

Owing to the fact that there is significant oil in the water, the organisms are coated with a fine layer of organic material, thus necessitating the usage of an ATP test kit which washes away the layer of oil prior to ATP testing. The kit employed for this testing is manufactured by LuminUltra and is identified as the Quench Gone Organic-Modified (QUO-M) test kit.

Furthermore, in order to ensure that adequate MCA was present to penetrate this oil layer (and have an apples to apples comparison in performance), the MCA was dosed at the same level as the MTC at a concentration of 200 ppm.

The MCA was tested at intervals between this period (30, 60, 180, and 240 minutes).

Bottles were collected and the initial concentration of ATP for each bottle was measured and then dosed with 200 ppm of MCA and MTC respectively and one bottle was not dosed to serve as a growth control.

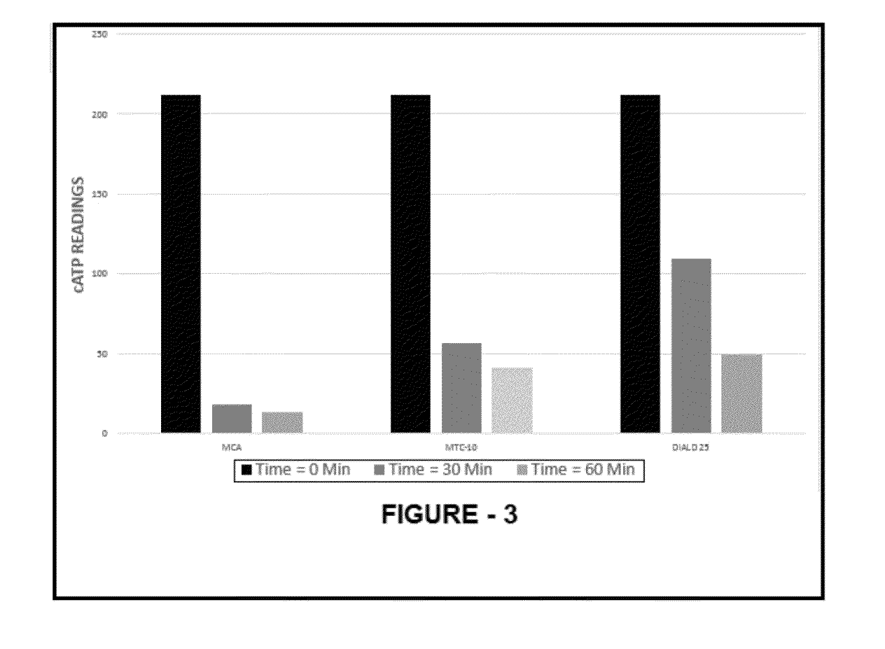

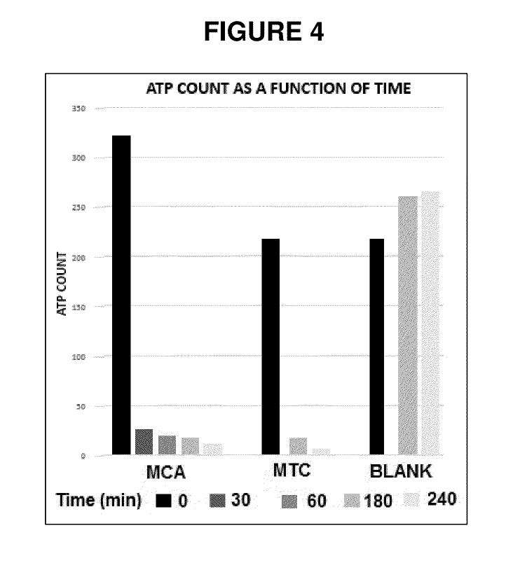

Tables 1 and 2 show the data from this testing, and FIGS. 3 and 4 shows the data in graphical format.

TABLE 1
RAW DATA RESULTS FOR KILL STUDY

| | TIME (Min) | | | | |
|---|---|---|---|---|---|
| SAMPLE | 0 | 30 | 60 | 180 | 240 |
| ID | ATP READINGS | | | | |
| MCA | 321.4 | 26.05 | 19.2 | 17.4 | 11.9 |
| MTC | 217.3 | NT | NT | 16.9 | 6.12 |
| BLANK | 217.2 | NT | NT | 261.2 | 265.3 |

As the data shows, ATP levels for MCA decreased from 321.4 to 26.05 within 30 minutes (a 92% reduction) was noted with the MCA within 30 minutes followed by a decline to a total ATP reduction to 11.9 (a 96% reduction) within 4 hours.

FIG. 4 shows the graphical data from Table-1. While the MTC performed slightly better, the attractiveness of the MCA is the ability to dose 24/7 as opposed to slug dosing for only 6 hours per week or less than one hour per day.

The data from Table-2 shows that a 92% kill was obtained within 30 minutes for MCA.

TABLE 2
PERCENT KILL RESULTS

| | TIME (Min) | | | | |
|---|---|---|---|---|---|
| SAMPLE | 0 | 30 | 60 | 180 | 240 |

| ID | PERCENT REDUCTION IN ATP LEVEL | | | | |
|---|---|---|---|---|---|
| MCA | N/A | 92% | 94% | 95% | 96% |
| MTC | N/A | N/A | N/A | 0.92 | 0.97 |

| | | | | | |
|---|---|---|---|---|---|
| BLANK | N/A | N/A | N/A | −20% | −22% |

FIG. 4 shows the graphical data from Table-2.

The MCA demand was calculated by subtracting the MCA after reacting with the demand in the influent water from the MCA added to the sample using the formula [MCA Demand of sample=MCA added−MCA read after 4 hours] and was calculated to be 47.5 ppm which is very close to the average demand for this field from previous visits of 47.9 ppm.

Previous testing had shown that the MCA was killing in 20 minutes what it took other biocides (i.e. MTC and Glutaraldehyde) to accomplish in four hours. Cell penetration for MCA was better than for MTC.

When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

It will be apparent to one of ordinary skill in the art that other ammonia salts, chlorine and/or bromine and/or halogenated chemicals may be employed to achieve the objectives of this disclosure and it is intended that the specifications and examples be considered as exemplary only with a true scope and spirit of the invention being indicated by the submitted claims and equivalents thereof. When reference is made to, e.g. chloramine above, any other haloamine can be used in combination or in place of the chloramine.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method for onsite generation of a haloamine comprising mixing an ammonium salt with water and optionally a base to form a stable composition which does not convert to a haloamine, mixing said stable composition with a halogen or halogen-containing compound under conditions in which all or a part of the ammonium salt is converted into a haloamine, and optionally injecting the resulting haloamine into an injection zone.

2. The method of claim 1, wherein the stable composition is placed in a portable storage container and transported to an on-site location where the haloamine is to be used, and then mixed with the halogen or halogen-containing compound to produce the haloamine.

3. The method according to claim 1, wherein the haloamine is selected from the group consisting of monochloramine, dichloramine, trichloramine, monobromamine, dibromamine, tribromamine, and mixture of two or more thereof.

4. The method according to claim 1, wherein the ammonium salt is selected from the group consisting of ammonium acetate; ammonium bicarbonate; ammonium bromide; ammonium chloride; ammonium fluoride; ammonium hexafluorophosphate; ammonium hydrogensulfate; ammonium nitrate; ammonium phosphate; ammonium sulfamate; ammonium sulfate; ammonium sulfite; ammonium trifluoroacetate; ammonium trifluoromethanesulfonate; and mixtures two or more thereof.

5. The method according to claim 1, wherein the halogen or chemical containing halogen is selected from the group consisting of sodium hypochlorite, sodium hypobromite, chlorine, bromine, a chlorine-releasing compound, a bromine-releasing compound, calcium hypochlorite, calcium hypobromite, a chlorinated hydantoin, a brominated hydantoins, Chloramine-T, Chloramine-B, and mixtures thereof.

6. The method according to claim 1, wherein the base is used and comprises sodium hydroxide or potassium hydroxide

7. The method according to claim 1, wherein the haloamine comprises monochloramine, the ammonium salt comprises ammonium sulfate, and sodium hypochlorite is used as the halogen-containing compound.

8. The method according to claim 1, wherein the produced haloamine is injected into an injection zone, wherein the injection zone comprises a) a geologically produced material that contains one or more solid, liquid, or gaseous hydrocarbons; b) a hydrocarbon deposit; c) a petroleum deposit; d) a hydrocarbon or petroleum product formation; e) a hydrocarbon, or petroleum containing product; f) a hydrocarbon, or petroleum extraction site including drilling, hydraulic fracturing, production, stimulation, and/or disposal sites; g) hydrocarbon or petroleum transportation facility or storage equipment including pipeline, mobile tanker loading facilities, storage tanks and/or h) a refining facility, products, processes-equipment, or combinations thereof and/or waters or fluids associated with items a-h, including waters and fluids associated with: i) drilling; j) stimulation; .k) production; l) hydraulic fracturing; and m) disposal.

9. The method according to claim 1, wherein the produced haloamine is injected into an injection zone, and the injection zone comprises a hydrocarbon or petroleum processing product or equipment selected from the group consisting of one or more pieces of equipment for extracting, processing, transportation, such as a pipeline for transporting hydrocarbons, storage, such as a vessel for storage of hydrocarbons, or refining hydrocarbons, or any and all waters such as fresh, brine, sea, brackish, or stored and fluids used in any hydrocarbon production processes including waters and fluids associated with: drilling; stimulation; production; hydraulic fracturing, and disposal.

10. The method according to claim 1, wherein the haloamine comprises a chloramine and/or bromamine, and is fed into an injection zone at a dosage rate covering the range of slug feed, intermittent feed and/or continuous feed.

11. The method according to claim 1, further comprising treating waters or fluids, including waters or fluids used or found in upstream, midstream and/or downstream petroleum operations, comprising fresh water, aquifer water, brine water, sea water, brackish water, river waters, lake waters, pond waters, stored waters or any combination thereof, with the produced haloamine.

12. The method according to claim 1, further comprising injecting the produced haloamine into an injection zone comprising (i) makeup waters or fluids (ii) recycled waters or fluids (iii) flowback waters or fluids, (iv) injection waters or fluids, (v) produced waters or fluids or (vi) other waters or fluids; found or employed in oil field: drilling; stimulation; hydraulic fracturing; production and/or disposal operations, in an amount sufficient to reduce, inactivate, destroy, or eliminate at least one or more organic sulfhydryl reducing agents and/or inorganic sulfide reducing agents, such as H2S.

13. The method according to claim 12, wherein the one or more reducing agents reduced, inactivated, destroyed or eliminated are selected from the group consisting of elemental sulfur, reduced sulfur compounds, reduced metals, reduced organic compounds, and mixtures thereof.

14. The method according to claim 1, further comprising injecting the produced haloamine into an injection zone comprising (i) makeup waters or fluids (ii) recycled waters or fluids (iii) flowback waters or fluids, (iv) injection waters or fluids, (v) produced waters or fluids or (vi) other waters or fluids found or employed in oil field: drilling; stimulation; hydraulic fracturing; production and/or disposal operations, in an amount sufficient to reduce, inactivate, destroy, or eliminate at least one or more: bacteria; algae; fungi; archaea; and/or other microbes.

15. A method for inhibiting or controlling bacteria, algae, fungi, other microbes, or organic sulfhydryl reducing agents and/or inorganic sulfide reducing agents, such as H2S contained in an oil or gas well, comprising contacting the well with one or more chloramines or bromamines.

16. The method according to claim 15, wherein the chloramine or bromamine is generated on the well-site.

17. The method according to claim 16, wherein the chloramine or bromamine is generated onsite by
reacting a previously formed product made by mixing an ammonium salt with water and optionally a base to form a stable composition which does not convert to a chloramine or bromamine,
with a halogen or halogen-containing compound under conditions in which all or a part of the ammonium salt is converted into a chloro or bromamine.

18. A system for generating a haloamine, comprising
a storage container comprising a stable composition which is a mixture of an ammonium salt with water and optionally a base which does not convert to a haloamine, and
a haloamine generator equipment, which is optionally portable.

19. A method for onsite generation of a haloamine comprising reacting halogen or a halogen-containing compound with a stable composition formed by mixing an ammonium salt with water and optionally a base, under conditions in which all or a part of the ammonium salt is converted into a haloamine.

20. A method of controlling bacteria and impurities in oil and gas field water, comprising treating the water with a chloramine or bromamine that has been generated onsite.
